(19) United States
(12) Patent Application Publication
(10) Pub. No.: US 2003/0211273 A1
(43) Pub. Date: Nov. 13, 2003

(54) Tire identification label

(76) Inventors: Karen Perry, Cincinnati, OH (US); Kevin Conwell, Fairfield, OH (US); Patrick Bush, Bloomfield, MI (US)

Correspondence Address: ORUM & ROTH, 53 WEST JACKSON BOULEVARD, CHICAGO, IL, 60604, US

(21) Appl. No.: 10/391,036

(22) Filed: Mar. 18, 2003

Related U.S. Application Data
(60) Provisional application No. 60/379,965, filed on May 10, 2002.

(51) Int. Cl. B32B 9/00

(52) U.S. Cl. 428/41.8; 428/42.1; 156/116

(57) ABSTRACT

A tire label is formed on printable plastic film stock preferably coated with a thickness of between 0.001 to 0.004 inches of a pressure sensitive rubber based adhesive. The adhesive may be applied in a pattern on the film stock leaving a pull-tab to allow easy removal of the label. When adhered to a tire sidewall the label is oriented with the pull-tab in the tread direction so that the tire mounting and testing procedures do not snare it. Machine-readable data is printed on the label in a machine readable 2D data matrix symbology alongside a human readable ascii serial number.

This application claims the benefit of U.S. Provisional Patent Application “Tire Identification Label” filed May 10, 2002, serial No. 60/379965, hereby incorporated by reference in the entirety.

### BACKGROUND OF THE INVENTION

1. Field of the Invention

The present invention relates to machine-readable labels. More specifically the invention relates to machine-readable labels for application upon vehicle tire sidewalls.

2. Description of Related Art

Recent tire recalls ordered by the National Highway Traffic Safety Administration (NHTSA) were much wider than necessary because no data existed as to which tire lots and/or tire manufacturing dates had been installed on specific vehicles. Recent legislation passed by the United States Congress now requires automobile manufacturers to implement a tracking system to link tire serial numbers to vehicle identification numbers (VIN). Therefore a need exists for a cost-effective tire identification system usable from the time of tire manufacture until the tire is matched and mounted to a specific vehicle so that the tire serial numbers may be associated with a VIN in the vehicle manufacturer's database.

The Automotive Industry Action Group (AIAG) recently published a guideline “tire and wheel identification standard” which discloses a tire tracking system using a label printed with a two-dimensional bar code symbol. The labels are to be applied on OEM production tires and later removed after final wheel and vehicle carriage assembly.

Previous tire identification systems include hand-stamping tires with lot and date codes using indelible ink. Low-density data capable systems include “bumpy bar codes” which are raised bar code symbols directly embossed or molded into the surface of the tire. The low data density of these systems prevent them from incorporating the required data storage volume and the molding technology required increases tire manufacturing costs while providing limited flexibility for incorporating on-demand variable data. Other technologies providing high-density machine readable data include U.S. Pat. No. 4,991,217 which discloses a passive radio frequency identification transponder tag which may be interrogated by a radio frequency field from outside of the tire. This solution is presently prohibitively expensive and is susceptible to radio wave interference and damage from vulcanization heat/pressure during the tire manufacturing/tag mounting process. U.S. Pat. No. 5,160,383 discloses a tire label permanently mounted to an inner liner of the tire for tracking of tire serial numbers throughout the entire life of the tire up to and including retreading of the tire. The label is manufactured using a SPBD/rubber blend which is permanently affixed to the inside of the tire where it is cured along with the tire in a mold by the heat and pressure of the vulcanization curing process. Mounted on the inside of the tire, the label is only readable when the tire casing has been removed from the tire rim. U.S. Pat. No. 4,010,354 discloses a magnetically encodable tag in a sequential tape format that is encoded with tire identifying data which is applied to the side wall material of a green tire. The magnetically encoded tape and associated encoding and decoding equipment increases the tire costs when compared to the present invention.

### SUMMARY OF THE INVENTION

A tire label formed on printable plastic film stock preferably coated with a thickness of between 0.001 to 0.004 inches of a pressure sensitive rubber based adhesive. The adhesive may be applied in a pattern on the film stock leaving a pull-tab to allow easy removal of the label. When adhered to a tire sidewall the label is oriented with the pull-tab in the tread direction so that the tire mounting and testing procedures do not snare it. Machine-readable data is printed on the label in a machine readable 2D data matrix symbology alongside a human readable ascii serial number.

### BRIEF DESCRIPTION OF THE DRAWINGS

FIG. 1 is a front view of a blank label showing the preferred label corner radius dimensions.

FIG. 2 is a back view of the label from FIG. 1 showing the adhesive and dry pull tab areas thereon.

FIG. 3 is a diagram showing the label layout upon a bulk media roll.

FIG. 4 is a front view of a sample label printed with data.

### DETAILED DESCRIPTION

The label face stock is required to be sturdy enough to withstand the tire manufacturing and assembly environment including warehouse storage, handling, shipping, trailers, conveyors, soaping, wheel mounting equipment, inflation, balancing, and load simulator operations and equipment. Because tire mounting machines and load simulation equipment actually contact the tire side wall and thus the label, the label is subject to severe stress. The label face stock should be able to resist tearing, abrasion, staining, grease, oil, heat, moisture, plasticizers, and UVB exposure. Therefore, label face stock may be between 0.001 inches and 0.008 inches thick formed out of, for example; a polyester label film, polyethylene napthalate, polypropylene, polyurethane, polyethylene, polystyrene, polycarbonate, polyolefin, polyamide, acetate, acrylic, acrylar, vinyl, polyvinyl fluoride, Tedlar, Tyvek, Teflon, and/or synthetic paper. A film stiffness of the label face stock should be between 20 and 80 mg (Gurley). This will allow good dispensing properties for self-stripping the label from the release liner on a label-dispensing unit, yet be flexible enough to conform to the curvature of a tire sidewall. The label face stock should have lay-flat properties to reduce label creasing and wrinkling and to prevent the dry-pull tab from lifting or folding back over the bar code symbol.

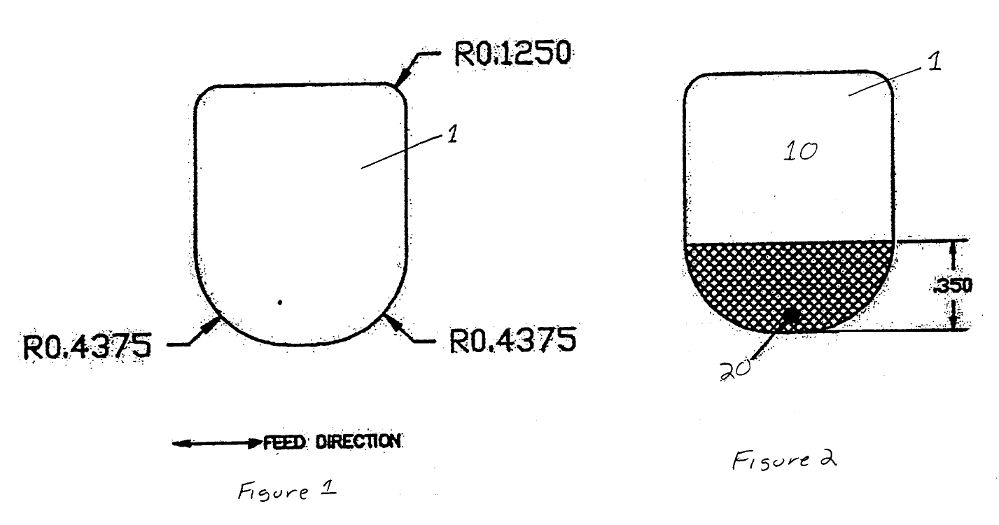

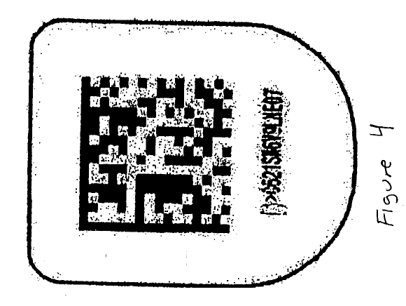

Configuring the label 1 as shown in FIG. 1 allows sufficient printable area to place a 2D machine-readable symbology and an ascii serial number thereon as shown in FIG. 4. The label 1 dimensions are selected to be small enough so that the label 1 will fit onto a smooth space available on the sidewall of any size/brand of tire. The selected radiuses resist rollover of the label face stock while the label is adhered to the tire sidewall.

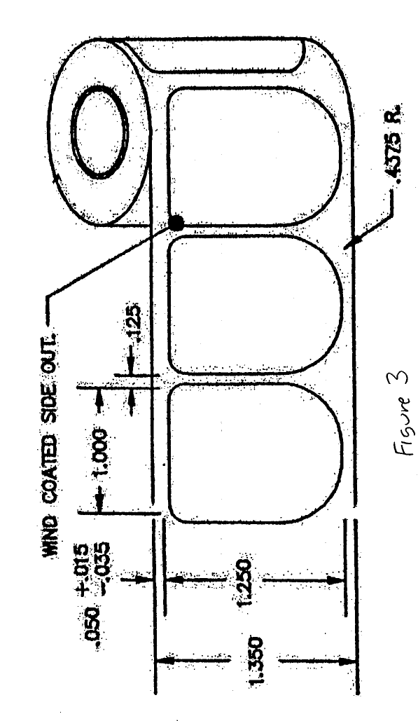

As shown in FIG. 2, the label may be configured with an adhesive area 10 and a dry-pull tab area 20. The dry-pull tab area 20 allows for easy removal of the label 1 once the tire has been mounted onto a vehicle and the data thereon scanned and assigned to the VIN database for that vehicle. Orienting the label 1 with the dry-pull tab pointing either at the tread or at the center of the tire allows the label to be subjected to increased sideways shear from the tire mounting, tire inflation and/or load simulation equipment which may be contacting the tire side wall.

The label adhesive is preferably a pressure sensitive rubber based adhesive coated in a thickness of between 0.001 and 0.004 inches. The adhesive bond should be strong between the label and the tire side wall, yet removable after the final wheel/vehicle carriage assembly. The adhesive should be selected to resist the migration of plasticizer and other low-molecular weight additives within the rubber tire compound as the tire ages or becomes exposed to elevated temperatures, for example within a trailer during storage/transportation during summer months. Further, a barrier coating may also be used between the adhesive and label to prevent plasticizer migration into the label which may weaken the label/adhesive bond and/or discolor the label face.

The label may be made in linered and/or linerless embodiments. In linered embodiments the release liner is preferably a super calendared densified Kraft with a basis weight between 30 to 60 lbs. per 3,000 sq. ft. and a thickness of between 0.002 and 0.004 inches. A side of the release liner contacting the adhesive is coated with a release layer, for example, a cured silicone. The other side of the release layer may be coated with a similar release layer to prevent blocking (sticking) of the roll wraps if there is adhesive bleed around the edges of the die cut labels.

As shown in FIG. 3, the rolls of label media may be laid out for minimum waste and die cut for easy separation of the printed label.

The label may be printed using, for example, thermal transfer ribbon material using a resin based carbon black ink. To maximize protection of the printed label, a clear protective over laminate film or overprint varnish may be used to resist abrasion of the label printed indicia.

The present invention is entitled to a range of equivalents as to be limited only by the scope of the following claims.

1. A removable tire side wall label, comprising:
a label face stock having a film stiffness of between 20 to 80 mg (Gurly), and a thickness of between 0.001 and 0.008 inches;
the label face stock coated on a first side with a pressure sensitive rubber based adhesive having a thickness of between 0.001 and 0.004 inches.

2. The label of claim 1, further including:
a barrier coating between the label face stock and the adhesive, whereby plasticizer migration from the adhesive into the label face stock is prevented.

3. The label of claim 1, further including:
a machine-readable indicia on a second side of the label face stock.

4. The label of claim 3, further including:
one of a clear protective over laminate film and an overprint varnish above the printed indicia.

5. The label of claim 3, wherein:
the printed indicia are formed using a resin based carbon black ink.

6. The label of claim 4, wherein:
the printed indicia is a 2D machine-readable symbology and an ascii representation of the data.

7. The label of claim 1, wherein:
a pull-tab portion of the first side of the label face stock is not coated with the adhesive.

8. The label of claim 1, further including:
a release liner, a first side of the release liner releasably adhered to the adhesive.

9. The label of claim 8, wherein:
the first side of the release liner is coated with a cured silicone release layer.

10. The label of claim 9, wherein:
a second side of the release liner is coated with a cured silicone release layer.

11. The label of claim 1, wherein:
the label is supplied in a media roll with a plurality of the labels die-cut for individual separation.

12. The label of claim 1, wherein:
the label has a minimum corner radius of not less than 0.125 inches.

13. The label of claim 1, wherein:
the label has a total surface area of less than 1.25 square inches.

14. A method for attaching a label to a tire, comprising the steps of:
locating a target area on a tire sidewall, the target area being substantially smooth; and
applying a label having: a label face stock film stiffness of between 20 to 80 mg (Gurly), a label face stock thickness of between 0.001 and 0.008 inches, a coating of pressure sensitive rubber based adhesive having a thickness of between 0.001 and 0.004 inches on a portion of a first side of the label face stock, an uncoated portion of the first side forming a pull-tab, the label applied with the pull-tab oriented in one of a tire tread and a tire center direction.
